(19) United States
(12) Patent Application Publication
(10) Pub. No.: US 2025/0220753 A1
(43) Pub. Date: Jul. 3, 2025

(54) Handling a Protocol Data Unit Session

(71) Applicant: Telefonaktiebolaget LM Ericsson (publ), Stockholm (SE)

(72) Inventors: Songmao Li, Shanghai (CN); Yunjie Lu, Shanghai (CN); Maria Cruz Bartolome Rodrigo, Torremocha de Jarama Madrid (ES)

(21) Appl. No.: 18/846,522

(22) PCT Filed: Mar. 16, 2023
(86) PCT No.: PCT/EP2023/056751

§ 371 Date: Sep. 12, 2024

(30) Foreign Application Priority Data
Mar. 16, 2022 (WO) PCT/CN2022/081283

(51) Int. Cl. H04W 76/18; H04W 76/20

(52) U.S. Cl. CPC H04W 76/18; H04W 76/20

(57) ABSTRACT

The present disclosure provides a method (500) performed by a Service Management Function (SMF) for handling a Protocol Data Unit (PDU) session, comprising: generating (S501) an error indication when receiving a request message for a service operation via a service communication proxy (SCP) from an Access and Mobility Management Function (AMF) after a User Equipment (UE) establishes the PDU session with the SMF and moves from a first service area to a second service area which is different from the first service area and not supported by the SMF, the SMF being a first SMF or an intermediate SMF (1-SMF) supporting the first service area; and transmitting (S503) a response message for the service operation including the error indication to the AMF via the SCP.

### TECHNICAL FIELD

The present disclosure generally relates to the technical field of telecommunication, and particularly to methods for handling a Protocol Data Unit (PDU) session and network function nodes thereof.

### BACKGROUND

This section is intended to provide a background to the various embodiments of the technology described in this disclosure. The description in this section may include concepts that could be pursued, but are not necessarily ones that have been previously conceived or pursued. Therefore, unless otherwise indicated herein, what is described in this section is not prior art to the description and/or claims of this disclosure and is not admitted to be prior art by the mere inclusion in this section.

In Fifth Generation (5G) networks, a Node Function (NF) is a 3rd Generation Partnership Project (3GPP) adopted or 3GPP defined processing function in a network, which has defined functional behavior and 3GPP defined interfaces. An NF may be implemented either as a network element on dedicated hardware, a software instance running on a dedicated hardware, or as a virtualized functional instantiated on an appropriate platform, e.g., on a cloud infrastructure.

FIGS. 1A to 1D illustrates different existing systems for handling service requests, as set out in 3GPP technical standard (TS) 23.501 V17.3.0. In more detail, FIGS. 1A and 1B illustrate respective systems (Model A and Model B) that use direct communication, while FIGS. 1C and 1D illustrate respective systems (Model C and Model D) that use indirect communication.

In the systems illustrated in FIGS. 1A and 1B, a service request is sent directly from an NF node of a service consumer to an NF node of a service producer. A response to the service request is sent directly from the NF node of the service producer to the NF node of the service consumer. Similarly, any subsequent service requests are sent directly from the NF node of the service consumer to the NF node of the service producer. The system illustrated in FIG. 1B also comprises a network repository function (NRF) node. Thus, in the system illustrated in FIG. 1B, the NF node of the service consumer can query the NRF node to discover suitable NF nodes of the service producer to which to send the service request. In response to such a query, the NF node of the service consumer can receive an NF profile for one or more NF nodes of the service producer and, based on the received NF profile(s) can select an NF node of the service producer to which to send the service request. In the system illustrated in FIG. 1A, the NRF node is not used and instead the NF node of the service consumer may be configured with the NF profile(s) of the NF node(s) of the service producer.

In the systems illustrated in FIGS. 1C and 1D, a service request is sent indirectly from the NF node of the service consumer to the NF node of the service producer via a service communication proxy (SCP) node. A response to the service request is sent indirectly from the NF node of the service producer to the NF node of the service consumer via the SCP node. Similarly, any subsequent service requests are sent indirectly from the NF node of the service consumer to the NF node of the service producer via the SCP node. The systems illustrated in FIGS. 1C and 1D also comprise an NRF node.

In the system illustrated in FIG. 1C, the NF node of the service consumer can query the NRF node to discover suitable NF nodes of the service producer to which to send the service request. In response to such a query, the NF node of the service consumer can receive an NF profile for one or more NF nodes of the service producer and, based on the received NF profile(s) can select an NF node of the service producer to which to send the service request. In this case, the service request sent from the NF node of the service consumer to the SCP node comprises the address of the selected NF node of the service producer. The NF node of the service consumer can forward the service request without performing any further discovery or selection. In case the selected NF node of the service producer is not accessible for any reason, it may be up to the NF node of the service consumer to find an alternative. In other cases, the SCP node may communicate with the NRF node to acquire selection parameters (e.g. location, capacity, etc.) and the SCP node may select an NF node of the service producer to which to send the service request.

In the system (Model D) illustrated in FIG. 1D, the NF node of the service consumer does not carry out the discovery or selection process. Instead, the NF node of the service consumer adds any necessary discovery and selection parameters (required to find a suitable NF node of the service producer) to the service request that it sends via the SCP node. The SCP node uses the request address and the discovery and selection parameters in the service request to route the service request to a suitable NF node of the service producer. Thus, in the system illustrated in FIG. 1D, where indirect communication with delegated discovery is used, the NF node of the service consumer sends the service request to the SCP node and provides within the service request to the SCP node the discovery and selection parameters necessary to discover and select an NF node of a service producer. The SCP node can perform discovery with the NRF node to discover a target NF node of the service producer to which to route the service request. The SCP node can discover a target NF node of the service producer in the manner indicated in 3GPP TS 23.502 V17.3.0.

For the fifth generation core (5GC), from 3GPP Release 16, the SCP node is included as a network element to allow indirect communication between an NF node of a service consumer and an NF node of a service producer. That is, the SCP node can be used in indirect routing scenarios. The indirect communication that is used can be either of the two indirect communications options described earlier with reference to FIGS. 1C and 1D. In the 5GC, the SCP node can be an NF node that provides centralized capabilities, such as service based interface (SBI) routing, NF discovery and selection, failover, message screening, etc. the SCP is used in indirect routing scenarios and one of the options to deploy SCP is model D, as described in 3GPP TS 23.501, see FIG. 1D:

In some scenarios, a client (e.g. an NF node of a service consumer) may need to initially select and/or reselect (e.g. in case of a failure) a server (e.g. an NF node of a service producer) among a possible plurality of (e.g. functionally equivalent) server instances. Commonly, this selection and/or reselection can be performed based on server characteristics (or properties). These characteristics may be any one or more of those that are defined in a profile of the server. The characteristics can include, for example, server instance, server service instance priority, locality, capacity, and/or load, etc.

As per the service definition in 3GPP TS 23.501 V17.3.0, the following has been defined: “Model D-Indirect communication with delegated discovery: Consumers do not do any discovery or selection. The consumer adds any necessary discovery and selection parameters required to find a suitable producer to the service request. The SCP uses the request address and the discovery and selection parameters in the request message to route the request to a suitable producer instance. The SCP can perform discovery with a Network Repository Function (NRF) and obtain a discovery result.”

In Model D, the SCP discovers the target NF service producer. As per the service definition in 3GPP TS 23.501 V17.3.0, the following service has been defined: “If Indirect Communication with delegated discovery is used, the NF service consumer sends the request to the SCP and provides within the service request to the SCP the discovery and selection parameters necessary to discover and select an NF service producer.”

The Intermediate Service Management Function (I-SMF) is introduced in 5GC to support Deployments Topologies with Specific SMF Service Areas (DTSSA). As indicated in 3GPP TS 23.501:

5.34 Support of Deployments Topologies with Specific SMF Service Areas

### 5.34.1 General

When the UE is outside of the Session Management Function (SMF) Service Area, or the current SMF cannot serve a target Data Network Access Identifier (DNAI) for traffic routing towards a Local Data Network (DN), an I-SMF is inserted between the SMF and the Access and Mobility Management Function (AMF). The I-SMF has an N11 interface with the AMF and an N16a interface with the SMF and is responsible of controlling the User Plane Functions (UPFs) that the SMF cannot directly control. The exchange of a Session Management (SM) context and forwarding of tunnel information if needed are done between two SMFs directly without involvement of the AMF.

### 5.34.2.2 Non-Roaming Architecture

The non-roaming architecture is depicted in FIG. 5.34.2.2-1 of 3GPP TS 23.501 (corresponding to FIG. 2 of the present disclosure, which may be further described in the following context) with an I-SMF insertion to the PDU Session without Uplink Classifier/Branching Point (UL-CL/BP), using reference point representation. It is to be noted that N16a is the interface between the SMF and the I-SMF, and N38 is the interface between I-SMFs.

### 5.34.3 I-SMF Selection, Visited-SMF (V-SMF) Reselection

The AMF is responsible of detecting when to add or to remove an I-SMF or a V-SMF for a PDU Session. For this purpose, the AMF gets from the NRF information about the Service Area and supported DNAI(s) of SMF(s).
During mobility events (such as Hand-Over or AMF change), if the service area of the SMF does not include a new UE location, then the AMF selects and inserts an I-SMF which can serve the UE location and Single Network Slice Selection Assistance Information (S-NSSAI). Conversely if the AMF detects that an I-SMF is no more/longer needed (as the service area of the SMF includes the new UE location), it removes the I-SMF and interfaces directly with the SMF of the PDU Session. If the AMF detects that the SMF cannot serve the UE location (e.g. due to mobility), then the AMF selects a new I-SMF serving the UE location. If the existing I-SMF (or V-SMF) cannot serve the UE location (e.g. due to mobility) and the service area of the SMF does not include the new UE location (or the PDU Session is Home Routed), then the AMF initiates an I-SMF (or V-SMF) change. A V-SMF change may take place either at intra Public Land Mobile Network (intra-PLMN) or inter-PLMN mobility.
If delegated SMF discovery is used at PDU Session establishment:
1. The AMF sends a Nsmf_PDUSession_CreateSMContext Request to the SCP and includes the parameters as defined in clause 6.3.2 of 3GPP TS 23.501 V17.3.0 (e.g. the Digital Data Network (DNN), required SMF capabilities, UE location) as discovery and selection parameters. If the SCP successfully selects an SMF matching all discovery and selection parameters, the SCP forwards the Nsmf_PDUSessionCreateSMContext Request to the selected SMF.
2. If the SCP cannot select an SMF matching all discovery and selection parameters, the SCP returns a dedicated error to the AMF. In this case the I-SMF also needs to be discovered.
3. Upon reception of the error from the SCP that an SMF matching all discovery and selection parameters cannot be found, the AMF performs the discovery and selection of the SMF from the NRF (thus not providing the UE location as a discovery parameter). The AMF may indicate the maximum number of SMF instances to be returned from NRF, i.e. SMF selection at NRF.
4. The AMF sends a Nsmf_PDUSession_CreateSMContext Request to the SCP, which includes the endpoint (e.g. Uniform Resource Identifier, URI) of the selected SMF and the discovery and selection parameters, as defined in clause 6.3.2 of 3GPP TS 23.501 V17.3.0, except the DNN and the required SMF capabilities, i.e. parameter for I-SMF selection. The SCP performs discovery and selection of the I-SMF and forwards the Nsmf_PDUSession_CreateSMContext Request to the selected I-SMF.
5. The I-SMF sends a Nsmf_PDUSession_Create Request towards the SMF via the SCP; the I-SMF uses the received endpoint (e.g. URI) of the selected SMF to construct the target destination to be addressed. The SCP forwards the Nsmf_PDUSession_Create Request to the SMF.
6. The SMF answers to the I-SMF that answers to the AMF; in this answer the AMF receives an I-SMF identifier (ID).
7. Upon reception of a response from the I-SMF, based on the received I-SMF ID, the AMF may obtain the SMF Service Area of the I-SMF from NRF. The AMF uses the SMF Service Area of the I-SMF to determine the need for I-SMF relocation upon subsequent UE mobility.

Session and Service Continuity (SSC) is indicated in 3GPP TS 23.501, as follows:

### 5.6.9 Session and Service Continuity

### 5.6.9.1 General

The support for session and service continuity in 5G System architecture enables to address the various continuity requirements of different applications/services for the UE. The 5G System supports different session and service continuity (SSC) modes defined in this clause. The SSC mode associated with a PDU Session does not change during the lifetime of a PDU Session. The following three modes are specified with further details provided in the next clause:
   With SSC mode 1, the network preserves the connectivity service provided to the UE. For the case of PDU Session of Internet Protocol version 4 (IPv4) or Internet Protocol version 6 (IPv6) or Internet Protocol version 4 version 6 (IPv4v6) type, the internet protocol (IP) address is preserved.
   With SSC mode 2, the network may release the connectivity service delivered to the UE and release the corresponding PDU Session(s). For the case of IPv4 or IPv6 or IPv4v6 type, the release of the PDU Session induces the release of IP address(es) that had been allocated to the UE.
   With SSC mode 3, changes to the user plane can be visible to the UE, while the network ensures that the UE suffers no loss of connectivity. A connection through new PDU Session Anchor point is established before the previous connection is terminated in order to allow for better service continuity. For the case of IPv4 or IPv6 or IPv4v6 type, the IP address is not preserved in this mode when the PDU Session Anchor changes.

An AMF can get a selected SMF service instance identifier (id) either from a 3gpp-Sbi-Producer-Id header as defined in 3GPP TS 29.500 or from SmContextCreatedData as defined in 3GPP TS 29.502.

As described in 3GPP TS 29.500:

5.2.3.2.8 3gpp-Sbi-Producer-Id
This header contains the NF Service Producer Instance ID (see clause 6.10.3.4 of 3GPP TS 29.500). The encoding of the header follows the Augmented Backus-Naur Form (ABNF) as defined in the Internet Engineering Task Force Request for Comments (IETF RFC) 7230.
3gpp-Sbi-Producer-Id=“3gpp-Sbi-Producer-Id” “:” OWS “nfinst=” nfInstanceIdvalue [OWS “;” “nfservinst=” nfServiceInstanceIdvalue] [OWS “,” “nfset=” nfSetIdvalue] [OWS “;” “nfserviceset=” nfServiceSetIdvalue]

As described in 3GPP TS 29.502:

TABLE 1
(which corresponds to Table 6.1.6.2.3-1 of 3GPP TS
29.502: Definition of type SmContextCreatedData)

| | | | | | |
|---|---|---|---|---|---|
| Attribute | Data | | | | |
| name | type | P | Cardinality | Description | Applicability |

| | | | | |
|---|---|---|---|---|
| . . . | | | | |
| smfServiceInstanceId | string | O | 0 . . . 1 | When present, this |
| | | | | information element (IE) |
| | | | | shall contain the |
| | | | | serviceInstanceId of the |
| | | | | SMF PDUSession service |
| | | | | instance serving the SM |
| | | | | Context, i.e. of: |
| | | | | the I-SMF, for a PDU |
| | | | | session with I-SMF; |
| | | | | the V-SMF, for a |
| | | | | home routed (HR) |
| | | | | PDU session; or |
| | | | | the SMF, for a non- |
| | | | | roaming or a local |
| | | | | breakout operator |
| | | | | (LBO) roaming PDU |
| | | | | session without I- |
| | | | | SMF. |
| | | | | This IE may be used by the |
| | | | | AMF to identify PDU |
| | | | | session contexts affected |
| | | | | by a failure or restart of the |
| | | | | SMF service instance (see |
| | | | | clause 6.2 of |
| | | | | 3GPP TS 23.527). |

An NF service producer (NFp) can indicate “no-retry” for an error response, as indicated in 3GPP TS 29.500, as follows:

5.2.3.3.8 3gpp-Sbi-Response-Info
3gpp-Sbi-Response-Info=“3gpp-Sbi-Response-Info” “:” 1 #(OWS parameter [*(“;” OWS parameter)])
parameter=parametername “=” RWS parametervalue
parametername=“request-retransmitted”/“nfinst”/“nfset”/“nfservinst”/“nfserviceset”/“context-transferred”/“no-retry”/token
The following parameters may be defined:
   request-retransmitted: This parameter indicates, in an error response, whether the SCP attempted to (re) transmit the request to alternative Hyper Text Transfer Protocol (HTTP) server instances. When present, it shall be set to “true” if so, and to “false” otherwise. See clause 6.10.8.1 of 3GPP TS 29.500.
   nfinst (NF instance), nfset (NF set), nfservinst (NF service instance), nfserviceset (NF service set): One or more of these parameters may be present in an error response, when the request-retransmitted is set to “true”. When present, it shall indicate the NF Instances, NF Sets, NF Service Instances or NF Service Sets that were attempted to serve the request. See clause 6.10.8.1 of 3GPP TS 29.500. The value of the nfinst, nfset, nfservinst and nfserviceset parameters shall be encoded as defined for the corresponding parameters in clause 5.2.3.2.5 of 3GPP TS 29.500.
   context-transferred: This parameter indicates, in an error response, whether the corresponding resource or context has been transferred to the HTTP server instance sending the response. When present, it shall be set to “true” if the request has been transferred, i.e. the subsequent requests towards the resource or context shall be sent to the HTTP server instance sending the response, and to “false” otherwise.
   no-retry: This parameter indicates, in an error response, whether the failed request can be retried at (an) other alternative HTTP server instance or not. When present, it shall be set to “true” if the failed request shall not be retried at other alternative NF instances, and to “false” otherwise.

### Example 3: 3gpp-Sbi-Response-Info: context-transferred=false; no-retry=true

However, if delegated SMF discovery (Model D) is used after a PDU session establishment procedure, there is no description in 3GPP how to handle the error situation when the SMF/I-SMF does not serve the UE due to mobility.

### SUMMARY

In order to at least solve any of the problems as described above, the present disclosure proposes technical solutions capable of at least supporting the DTSSA with UE mobility for handling a PDU session, e.g. in model D.

According to a first aspect of the present disclosure, there is provided a method performed by a Service Management Function (SMF) for handling a Protocol Data Unit (PDU) session. The method comprises: generating an error indication when receiving a request message for a service operation via a service communication proxy (SCP) from an Access and Mobility Management Function (AMF) after a User Equipment (UE) establishes the PDU session with the SMF and moves from a first service area to a second service area which is different from the first service area and not supported by the SMF, the SMF being a first SMF or an intermediate SMF (I-SMF) supporting the first service area; and transmitting a response message for the service operation including the error indication to the AMF via the SCP.

In an exemplary embodiment, the SMF may wait for an Intermediate-SMF (I-SMF) procedure to be completed by the AMF without modifying or releasing the PDU session.

In an exemplary embodiment, the error indication may be generated when the following conditions are all met: the UE is out of the first service area of the SMF; and Deployments Topologies with specific SMF Service Areas (DTSSA) is supported by the AMF.

In an exemplary embodiment, the response message for the service operation including the error indication may further include an indication to indicate the SCP shall not perform a reselection procedure for this error response.

In an exemplary embodiment, a 3gpp-Sbi-Response-Info header of the response message for the service operation may comprise the indication to indicate the SCP shall not perform a reselection procedure for this error response. For example, the indication may be included by including a 3gpp-Sbi-Response-Info header with “no-retry=true” in the response message for the service operation.

In an exemplary embodiment, if the PDU session is established without an I-SMF, an I-SMF insertion procedure, as the I-SMF procedure, may be performed for inserting an I-SMF supporting the second service area.

In an exemplary embodiment, if the PDU session is established with the first SMF through a first I-SMF supporting the first service area, and the second service area is not supported by both the first SMF and the first I-SMF, an I-SMF change procedure, as the I-SMF procedure, may be performed for changing the first I-SMF to a second I-SMF supporting the second service area.

In an exemplary embodiment, if the PDU session is established with the first SMF through an I-SMF supporting the first service area, and the second service area is supported by the first SMF, an I-SMF removal procedure, as the I-SMF procedure, may be completed for removing the I-SMF supporting the first service area.

In an exemplary embodiment, the method performed by the SMF may be applied in an indirect communication with delegated SMF discovery (Model D) in a fifth generation (5G) core after a PDU session establishment procedure.

In an exemplary embodiment, the SMF is a Visited-SMF or a Home-SMF. For example, a role of the SMF can further be a Visited-SMF or a Home-SMF.

According to a second aspect of the present disclosure, there is provided a method performed by an AMF for handling a PDU session. The method comprises: transmitting a request message for a service operation to the SMF via an SCP after a UE establishes the PDU session with the SMF and moves from a first service area to a second service area which is different from the first service area and not supported by the SMF, the SMF being a first SMF or an I-SMF supporting the first service area; and receiving a response message for the service operation including an error indication from the SMF via the SCP.

In an exemplary embodiment, the AMF may perform an I-SMF procedure based on the received response message for the service operation including an error indication.

In an exemplary embodiment, if the PDU session is established without an I-SMF, an I-SMF insertion procedure, as the I-SMF procedure, may be performed for inserting an I-SMF supporting the second service area.

In an exemplary embodiment, if the PDU session is established with the first SMF through a first I-SMF supporting the first service area, and the second service area is not supported by both the first SMF and the first I-SMF, an I-SMF change procedure, as the I-SMF procedure, may be performed for changing the first I-SMF to a second I-SMF supporting the second service area.

In an exemplary embodiment, if the PDU session is established with the first SMF through an I-SMF supporting the first service area, and the second service area is supported by the first SMF, an I-SMF removal procedure, as the I-SMF procedure, may be performed for removing the I-SMF supporting the first service area.

In an exemplary embodiment, the AMF may perform a NRF discovery from the NRF with a service instance ID of the first SMF to get supported service areas of the first SMF.

In an exemplary embodiment, the AMF may obtain supported service areas of the I-SMF or the second I-SMF from NRF.

In an exemplary embodiment, the error indication may be generated when the following conditions are all met: the UE is out of the first service area of the SMF; and Deployments Topologies with specific SMF Service Areas (DTSSA) is supported by the AMF.

In an exemplary embodiment, the response message for the service operation including the error indication may further include an indication to indicate the SCP shall not perform a reselection procedure for this error response.

In an exemplary embodiment, a 3gpp-Sbi-Response-Info header of the response message for the service operation comprises the indication to indicate the SCP shall not perform a reselection procedure for this error response. For example, the indication may be included by including a 3gpp-Sbi-Response-Info header with “no-retry=true” in the response message for the service operation.

In an exemplary embodiment, the method performed by the AMF may be applied in an indirect communication with delegated SMF discovery (Model D) in 5G core after a PDU session establishment procedure.

In an exemplary embodiment, the SMF is a Visited-SMF or a Home-SMF. For example, a role of the SMF can further be a Visited-SMF or a Home-SMF.

According to a third aspect of the present disclosure, there is provided a Service Management Function (SMF) for handling a PDU session. The SMF may comprise: a generating unit configured to generate an error indication when receiving a request message for a service operation via a service communication proxy (SCP) from an Access and Mobility Management Function (AMF) after a UE establishes the PDU session with the SMF and moves from a first service area to a second service area which is different from the first service area and not supported by the SMF, the SMF being a first SMF or an intermediate SMF, I-SMF, supporting the first service area; and a transmitting unit configured to transmit a response message for the service operation including the error indication to the AMF via the SCP.

According to a fourth aspect of the present disclosure, there is provided a Service Management Function (SMF). The SMF comprises at least one processor configured to operate in accordance with any of the methods of the first aspect of the disclosure. In some embodiments, the SMF may comprise at least one memory storing instructions which, when executed on the at least one processor, cause the at least one processor to perform any of the methods according to the first aspect of the present disclosure.

According to a fifth aspect of the present disclosure, there is provided an Access and Mobility Management Function (AMF) for handling a PDU session. The AMF may comprise: a transmitting unit configured to transmit a request message for a service operation to the SMF via a service communication proxy (SCP) after a UE establishes the PDU session with the SMF and moves from the first service area to a second service area which is different from the first service area and not supported by the SMF, the SMF being a first SMF or an intermediate SMF, I-SMF, supporting the first service area; and a receiving unit configured to receive a response message for the service operation including an error indication from the SMF via the SCP.

According to a sixth aspect of the present disclosure, there is provided an Access and Mobility Management Function (AMF). The AMF comprises at least one processor configured to operate in accordance any of the methods according to the second aspect of the present disclosure. In some embodiments, the AMF comprises at least one memory storing instructions which, when executed on the at least one processor, cause the at least one processor to perform any of the methods according to the second aspect of the present disclosure.

According to a seventh aspect of the present disclosure, there is provided a computer readable storage medium having a computer program including instructions stored thereon, the instructions, when executed by at least one processor, cause the at least one processor to perform any of the methods according to the first aspect of the present disclosure and/or any of the methods according to the second aspect of the present disclosure.

According to an eighth aspect of the present disclosure, there is provided a computer program comprising instructions which, when executed by at least one processor, cause the at least one processor to perform the method according to any of the methods according to the first aspect of the present disclosure and/or any of the methods according to the second aspect of the present disclosure.

According to a ninth aspect of the present disclosure, there is provided a computer program product comprising the computer program and the computer readable storage medium.

The technical solutions according to the exemplary embodiments of the present disclosure as described above provide a mechanisms that can generate a dedicated error for SMF service areas (e.g. in an indirect communication, such as one using delegated discovery (model D) in 5GC) and thus, for example, support the DTSSA with UE mobility for PDU session handling (e.g., PDU session modification, etc.), such as in model D.

### BRIEF DESCRIPTION OF THE DRAWINGS

The objects, advantages and characteristics of the present disclosure will be more apparent, according to descriptions of preferred embodiments in connection with the drawings, wherein:

FIGS. 1A-1D schematically show different existing systems with Models A-D for handling service requests;

FIG. 2 schematically shows a non-roaming architecture with an I-SMF insertion to the PDU Session with no UL-CL/BP, using reference point representation;

FIG. 3 schematically shows an existing scenario in which a PDU session is established without an I-SMF;

FIG. 4 schematically shows another existing scenario in which a PDU session is established with an I-SMF;

FIG. 5 schematically shows a method performed by an SMF according to an exemplary embodiment of the present disclosure;

FIG. 6 schematically shows a method performed by an AMF according to an exemplary embodiment of the present disclosure;

FIG. 7 schematically shows an exemplary signaling diagram of PDU Session Establishment with DTSSA in Model D where a method performed by an SMF and/or an AMF according to exemplary embodiments of the present disclosure is applied;

FIG. 8 schematically shows another exemplary signaling diagram of PDU Session Establishment with DTSSA in Model D where a method performed by an SMF and/or an AMF according to exemplary embodiments of the present disclosure is applied;

FIG. 9 schematically shows another exemplary signaling diagram of PDU Session Establishment with DTSSA in Model D where a method performed by an SMF and/or an AMF according to exemplary embodiments of the present disclosure is applied;

FIGS. 10A-10B schematically show a structural block diagram of an SMF for handling a PDU session according to exemplary embodiments of the present disclosure; and

FIGS. 11A-11B schematically show a structural block diagram of an AMF for handling a PDU session according to exemplary embodiments of the present disclosure.

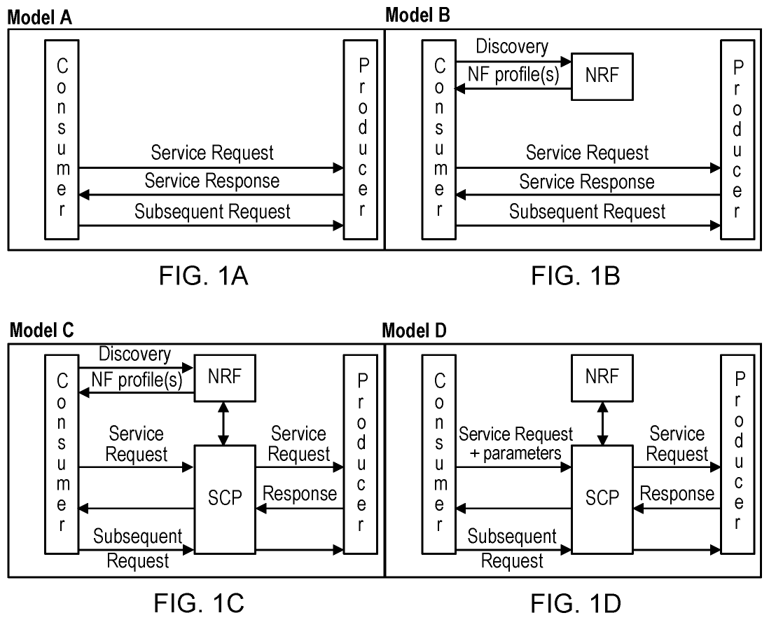

It should be noted that throughout the drawings, same or similar reference numbers are used for indicating same or similar elements; various parts in the drawings are not drawn to scale, but only for an illustrative purpose, and thus should not be understood as any limitations and constraints on the scope of the present disclosure.

### DETAILED DESCRIPTION

Hereinafter, the principle and spirit of the present disclosure will be described with reference to illustrative embodiments. Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art. Additional information may make reference to the following documents, which are incorporated herein in their entirety by reference:
[1] 3GPP TS 23.501, V17.3.0, “System architecture for the 5G System (5GS);
[2] 3GPP TS 29.500, V17.5.0: “5G System; Technical Realization of Service Based Architecture; Stage 3”;
[3] 3GPP TS 29.502, V17.3.0: “5G System; Session Management Services; Stage 3”; and
[4] 3GPP TS 23.502 V17.3.0: Procedures for the 5G System (5GS).

References in this specification to “one embodiment,” “an embodiment,” “an example embodiment,” etc. indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of the person skilled in the art to affect such feature, structure, or characteristic in connection with other embodiments whether or not explicitly described.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first” and “second,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” refers to a device in a wireless communication network via which a terminal device or another network node accesses the network and receives services therefrom. The network node refers to any Network Function (NF), a base station (BS), an Access Point (AP), or any other suitable device in the wireless communication network. The BS may be, for example, a node B (NodeB or NB), an evolved NodeB (eNodeB or eNB), or gNB, a Remote Radio Unit (RRU), a radio header (RH), a remote radio head (RRH), a relay, a low power node such as a femto, a pico, and so forth. Yet further examples of the network node may include multi-standard radio (MSR) radio equipment such as MSR BSs, network controllers such as radio network controllers (RNCs) or base station controllers (BSCs), base transceiver stations (BTSs), transmission points, transmission nodes. More generally, however, the network node may represent any suitable device (or group of devices) capable, configured, arranged, and/or operable to enable and/or provide a terminal device access to the wireless communication network or to provide some service to a terminal device that has accessed the wireless communication network.

In some embodiments, the non-limiting terms wireless device or UE are used interchangeably. The UE herein can be any type of wireless device capable of communicating with a network node or another wireless device over radio signals, such as wireless device. The UE may also be a radio communication device, target device, device-to-device (D2D) wireless device, machine type wireless device or wireless device capable of machine to machine communication (M2M), low-cost and/or low-complexity wireless device, a sensor equipped with wireless device, Tablet, mobile terminals, smart phone, laptop embedded equipped (LEE), laptop mounted equipment (LME), universal serial bus (USB) dongles, Customer Premises Equipment (CPE), an Internet of Things (IoT) device, or a Narrowband IoT (NB-IOT) device, etc.

Note that although terminology from one particular wireless system, such as, for example, 3GPP long-term evolution (LTE) and/or New Radio (NR), may be used in this disclosure, this should not be seen as limiting the scope of the present disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a UE or a network node may be distributed over a plurality of UEs and/or network nodes. In other words, it is contemplated that the functions of the network node and UE described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

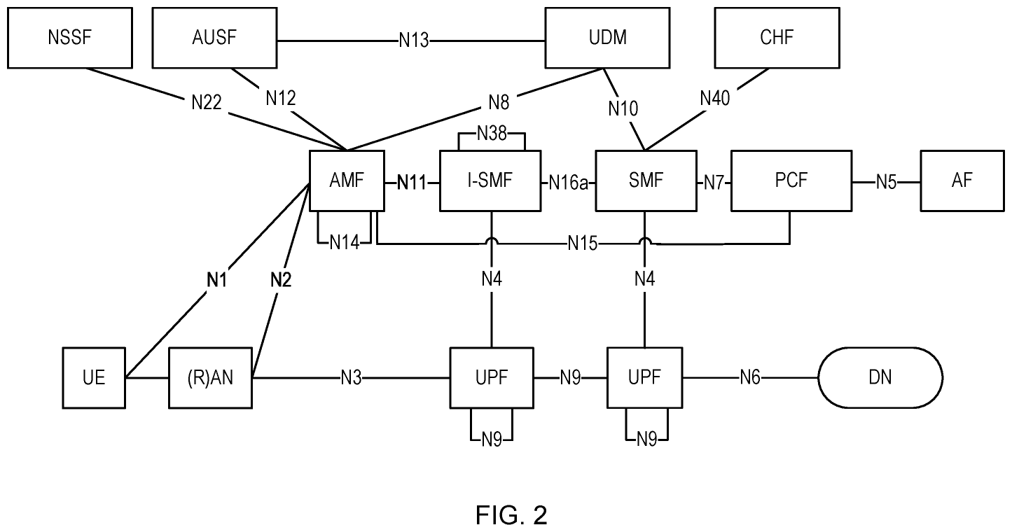

The non-roaming architecture depicted in FIG. 2 with an I-SMF insertion to the PDU Session with no UL-CL/BP, using reference point representation, will be introduced briefly herein for understanding, where interaction between any two NFs is represented by a point-to-point reference point/interface.

Seen from the access side, the 5G network architecture shown in FIG. 2 comprises a plurality of User Equipment (UEs) connected to either a Radio Access Network (RAN) or an Access Network (AN) directly as well as an Access and Mobility Management Function (AMF) indirectly, for example, via the RAN or AN. Typically, the R(AN) comprises base stations, e.g. such as evolved Node Bs (eNBs) or 5G base stations (gNBs) or similar. Seen from the core network side, the 5G core NFs shown in FIG. 2 include a Network Slice-specific and Standalone Non-Public Network (SNPN) Authentication and Authorization Function (NSSAAF), a Network Slice Selection Function (NSSF), an Authentication Server Function (AUSF), a Unified Data Management (UDM), a Network Slice Admission Control Function (NSACF), an Access and Mobility Management Function (AMF), a Session Management Function (SMF), a Policy Control Function (PCF), an Application Function (AF), and a User Plane Function (UPF).

Reference point representations of the 5G network architecture are used to develop detailed call flows in the normative standardization. The N1 reference point is defined to carry signaling between the UE and the AMF. The reference points for connecting between the AN and the AMF and between the AN and the UPF are defined as N2 and N3, respectively. There is a reference point, N11, between the AMF and the SMF, which implies that the SMF is at least partly controlled by the AMF. N4 is used by the SMF and the UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since the PCF applies policy to the AMF and the SMF, respectively. N12 is required for the AMF to perform authentication of the UE. N8 and N10 are defined because the subscription data of the UE is required for the AMF and the SMF.

The 5G core network aims at separating user plane and control plane. The user plane carries user traffic while the control plane carries signaling in the network. In FIG. 2, the UPF is in the user plane and all other NFs, i.e., AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and the SMF are independent functions in the control plane. Separated, the AMF and the SMF allow independent evolution and scaling. Other control plane functions like the PCF and the AUSF can be separated as shown in FIG. 2. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions, such as forwarding operations between different UPFs.

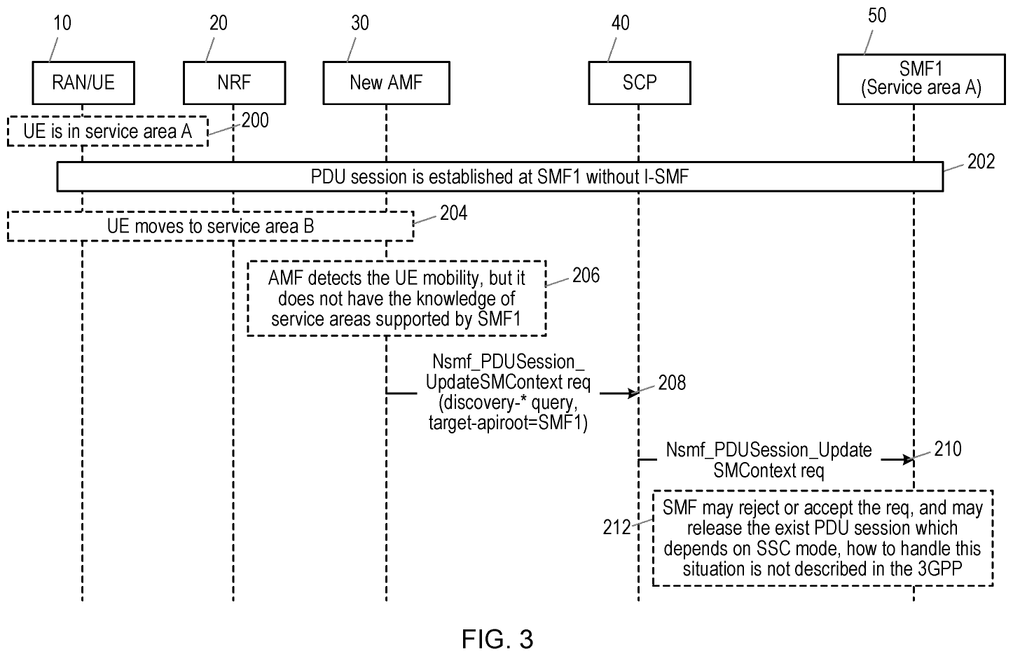

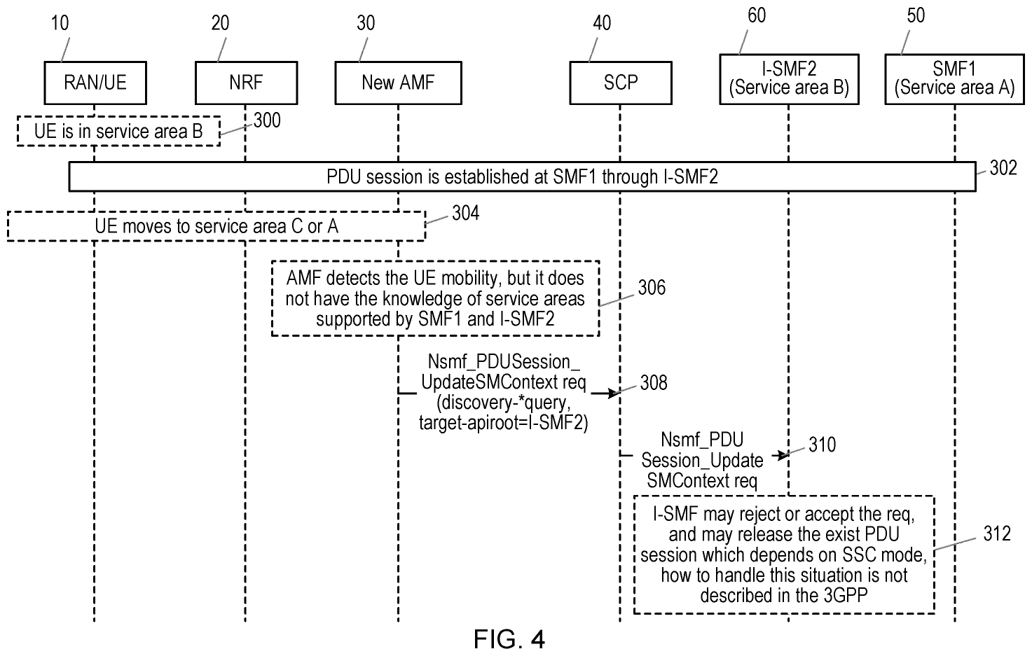

As mentioned earlier, if delegated SMF discovery (Model D) is used after a PDU session establishment procedure, there is no description in 3GPP of how to handle an error situation when an SMF/I-SMF does not serve a UE due to mobility. FIG. 3 and FIG. 4 describe the issues in this case.

The “New AMF” in the figures means the new AMF to which the UE connects due to mobility. During the mobility handling, the new AMF gets some information of the SMF/I-SMF from the old AMF, but it does not have the knowledge of service areas supported by the SMF/I-SMF. For simplicity, the below description only uses the term “AMF” to stand for “New AMF”.

FIG. 3 schematically shows an existing scenario (Case 1) in which a PDU session is established without an I-SMF. Particularly, the following steps may be performed in Case 1. The steps can involve any one or more of a UE (or RAN) 10, an NRF 20, an AMF 30, an SCP 40, and an SMF (“SMF 1”) 50.

In step 200 of FIG. 3, the UE 10 is in a service area A. The SMF1 50 supports service area A.

In step 202 of FIG. 3, delegated SMF discovery is used at PDU Session establishment. The SCP 40 selects an SMF matching all discovery and selection parameters. In this example, SMF1 50 is selected. The PDU session is established successfully with the selected SMF1 50.

In step 204 of FIG. 3, the UE 10 moves from service area A to service area B, and service area B is not supported by SMF1 50. In step 206 of FIG. 3, the AMF 30 detects the UE mobility, but the AMF 30 does not have the knowledge of serving areas supported by the associated SMF1 50.

In step 208 of FIG. 3, the AMF 30 cannot determine whether an I-SMF insertion procedure shall be executed, so the AMF 30 sends a Nsmf_PDUSession_UpdateSMContext request with a 3gpp-sbi-target-apiRoot header pointing to the associated SMF1 50 via the SCP 40. In step 210 of FIG. 3, the SCP 40 forwards the Nsmf_PDUSession_UpdateSMContext request to the SMF1 50 according to the 3gpp-sbi-target-apiRoot header.

In step 212 of FIG. 3, the UE 10 is outside of the service area supported by the SMF1 50. The SMF1 50 may react differently depending on the SSC (Session and Service Continuity) modes in use. For example, if an SSC2 mode is used, SMF1 50 may reject the Nsmf_PDUSession_UpdateSMContext request, and may trigger the PDU session release (with reactivation) procedure. As a result, the existing PDU session may be affected.

Nevertheless, how to handle the error case for a request for a service operation (e.g., Nsmf_PDUSession_UpdateSMContext request) in related NF nodes (e.g., AMF, SMF/I-SMF, etc.), such as in Model D, is not described in 3GPP either.

FIG. 4 schematically shows another existing scenario (Case 2) in which a PDU session is established with an I-SMF. Particularly, the following steps may be performed in Case 2. The steps can involve any one or more of a UE (or RAN) 10, an NRF 20, an AMF 30, an SCP 40, an SMF (“SMF 1”) 50, and an I-SMF (“I-SMF 2”) 60.

In step 300 of FIG. 4, the UE 10 is in service area B. The SMF1 50 supports service area A and the I-SMF2 60 supports service area B.

In step 302 of FIG. 4, delegated SMF discovery is used at PDU Session establishment. The SCP 40 selects an SMF matching all discovery and selection parameters. In this example, as described in clause 5.34.3 of TS 23.501, the PDU session is established successfully with the selected SMF1 50 through the I-SMF2 60.

In step 304 of FIG. 4, the UE 10 moves from service area B to service area C or A, and the I-SMF2 60 does not support service area C. In step 306 of FIG. 4, the AMF 30 detects the UE mobility, but the AMF 30 does not have the knowledge of serving areas supported by the associated I-SMF2 60 and anchor SMF1 50.

In step 308 of FIG. 4, the AMF 30 cannot determine whether the I-SMF 60 change or removal procedure shall be executed, so the AMF 30 will send a Nsmf_PDUSession_UpdateSMContext request with a 3gpp-sbi-target-apiRoot header pointing to the associated I-SMF2 6-via the SCP 40. In step 310 of FIG. 4, the SCP 40 forwards the Nsmf_PDUSession_UpdateSMContext request to the I-SMF2 60 according to the 3gpp-sbi-target-apiRoot header.

In step 312 of FIG. 4, the UE 10 is outside of the service area supported by the I-SMF2 60. The I-SMF2 60 may react differently depending on the SSC (Session and Service Continuity) modes in use. For example, if an SSC2 mode is used, the I-SMF2 60 may reject the Nsmf_PDUSession_UpdateSMContext request, and may trigger the PDU session release (with reactivation) procedure. As a result, the existing PDU session may be affected.

Nevertheless, how to handle the error case for a request for a service operation (e.g., Nsmf_PDUSession_UpdateSMContext request) in related NF nodes (e.g., AMF, SMF/I-SMF, etc.), such as in Model D, is not described in 3GPP either.

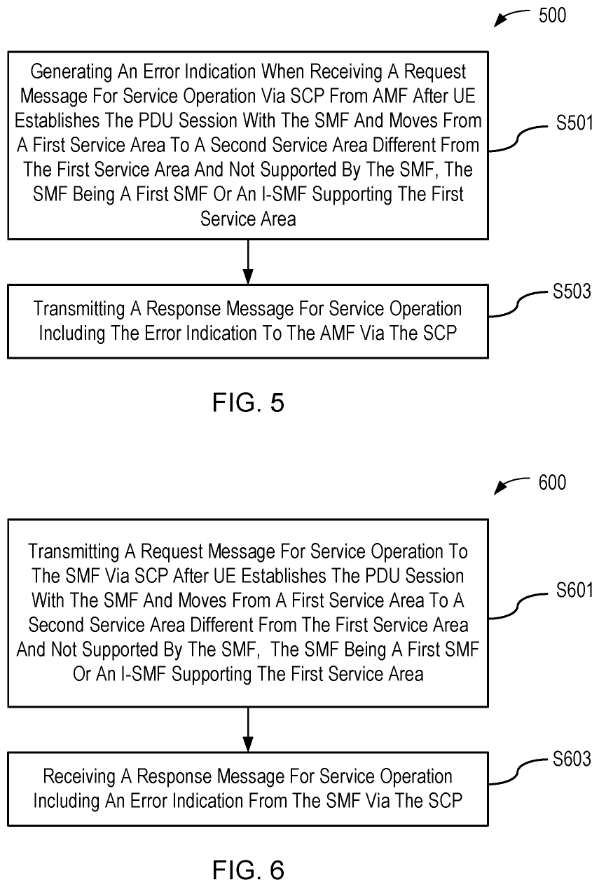

Hereinafter, a method 500 performed by an SMF for handling a PDU session according to an exemplary embodiment of the present disclosure will be described with reference to FIG. 5. The method can be applied after a PDU session has been established with the SMF.

As shown in FIG. 5, the method 500 includes at least steps S501 and S503.

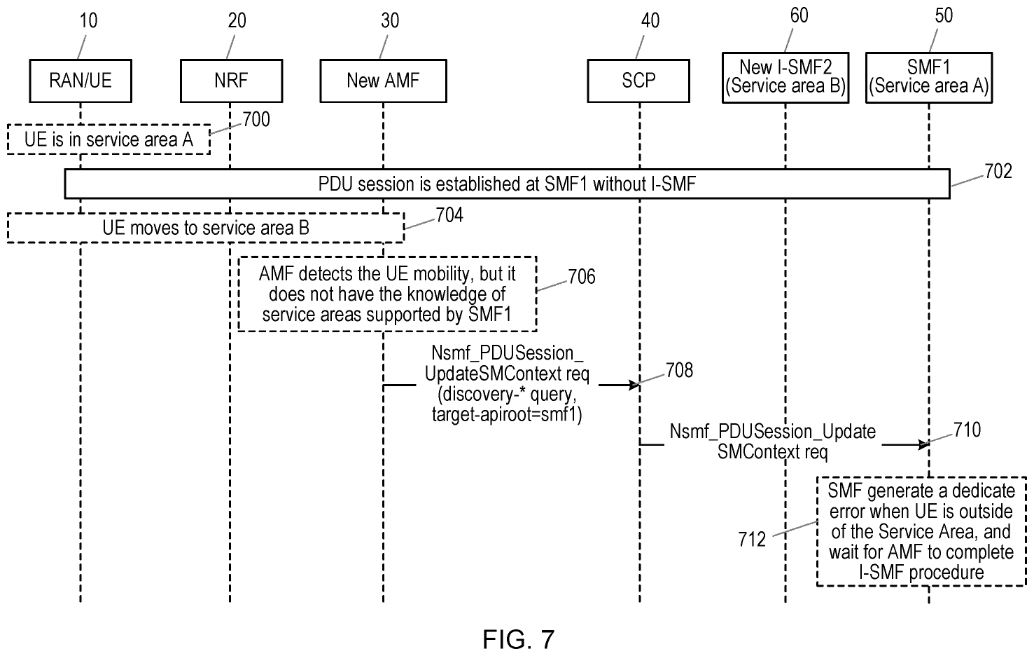

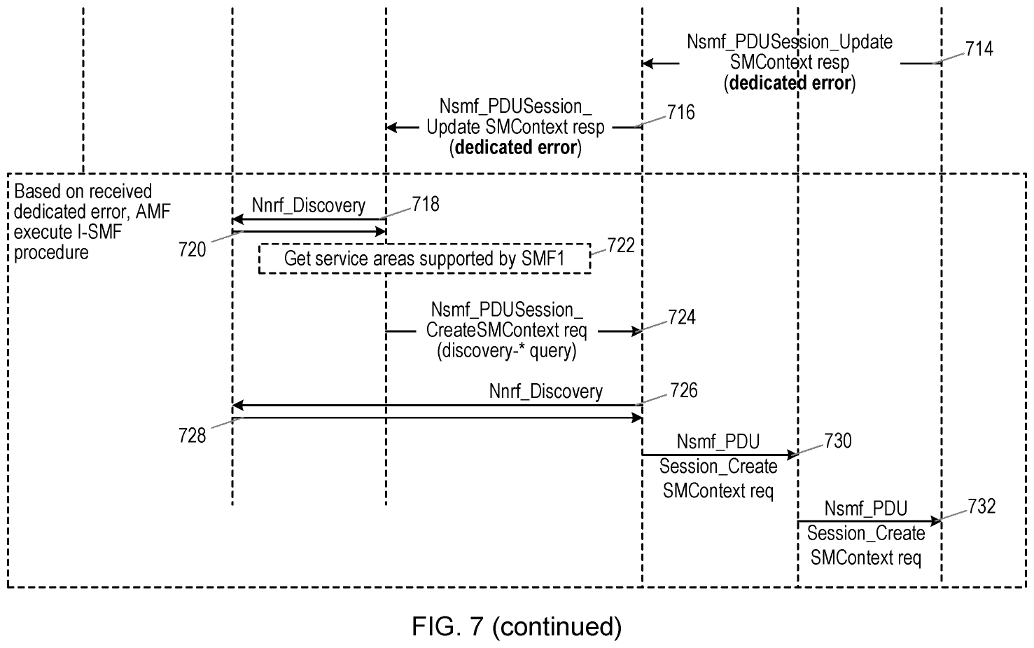

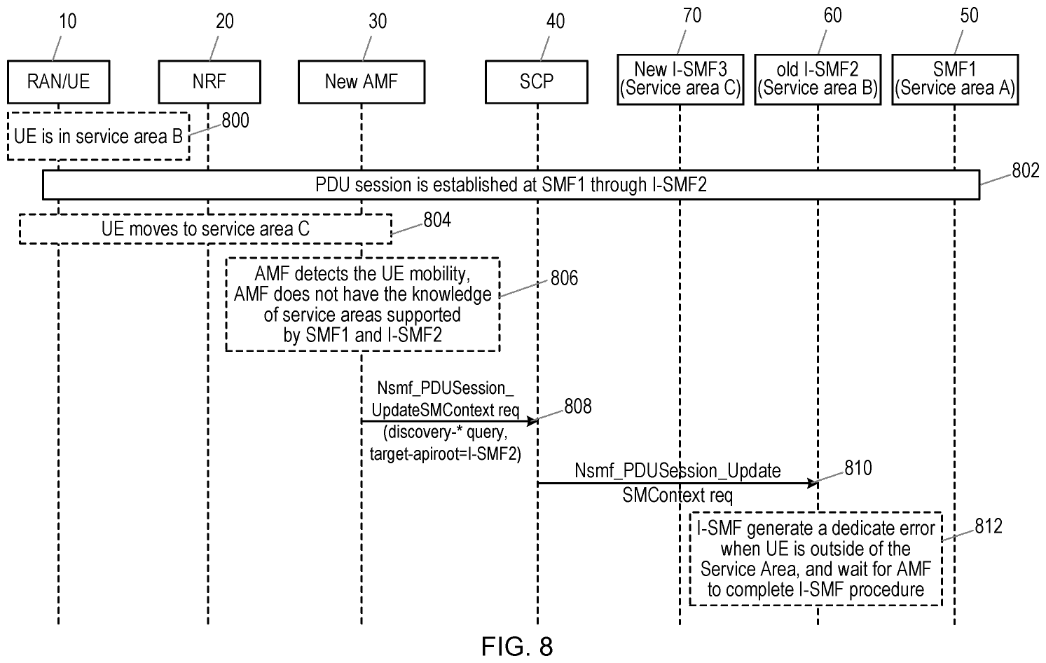

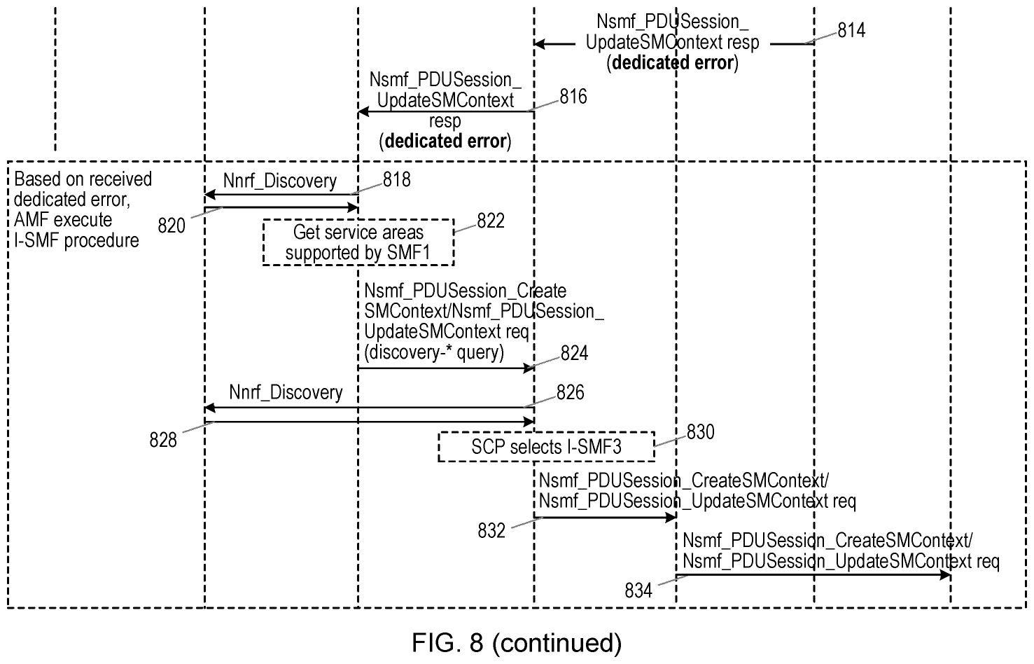

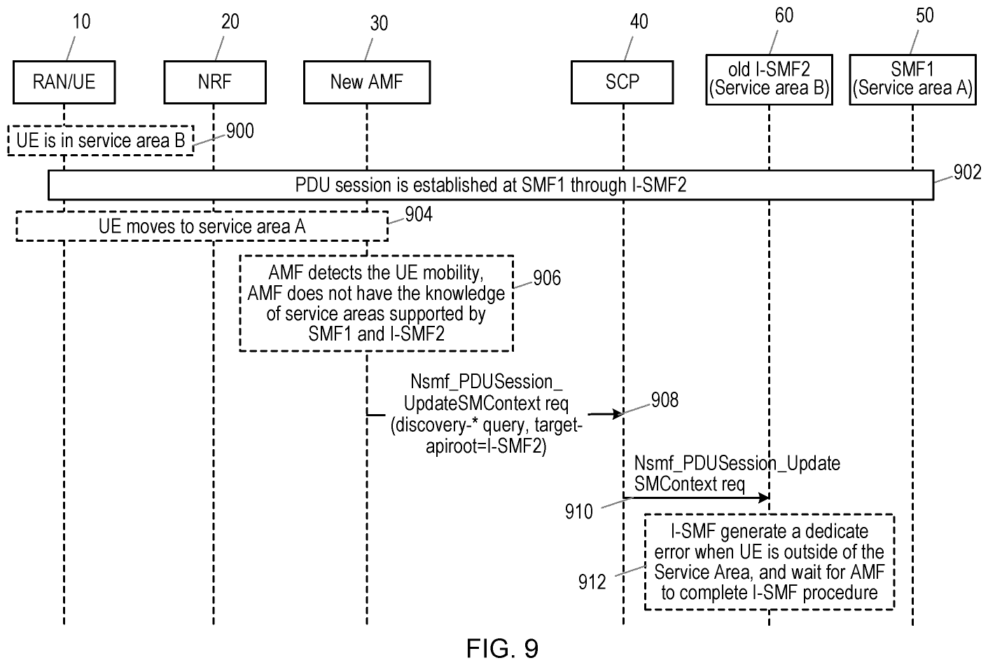

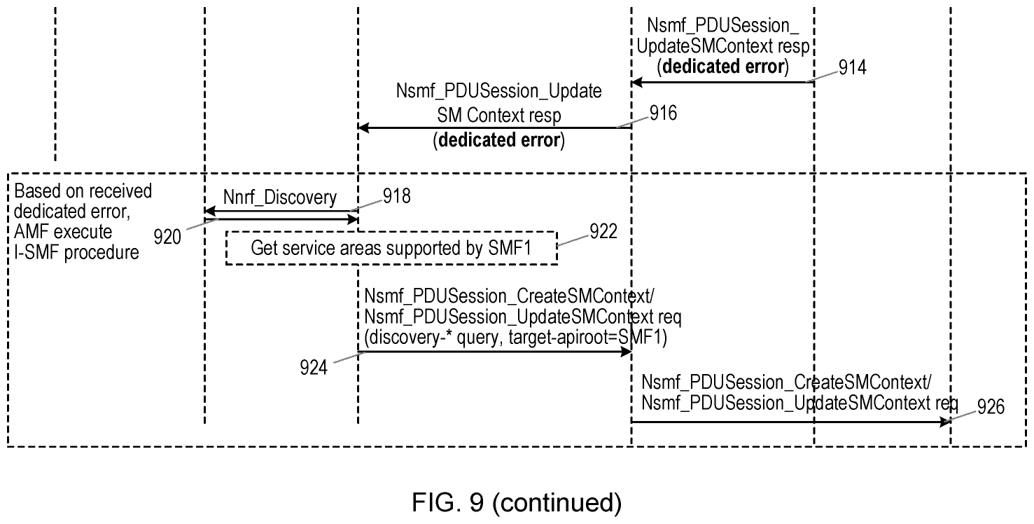

In step S501 of FIG. 5, after a UE establishes a PDU session with the SMF and moves from the first service area to a second service area which is different from the first service area and not supported by the SMF, the SMF generates an error indication when receiving a request message for a service operation via a service communication proxy (SCP) from an Access and Mobility Management Function (AMF). The SMF can be a first SMF (e.g., SMF1 in FIG. 7) or an I-SMF (e.g., old I-SMF2 in FIG. 8 or 9) supporting the first service area.

As an example, the error indication may be a dedicated error generated for indicating the UE's current location cannot be served by the associated SMF or I-SMF. The error indication may be generated when the following conditions are all met: the UE is out of the first service area of the SMF; and Deployments Topologies with specific SMF Service Areas (DTSSA) is supported by the AMF.

As an example, the request message for the service operation may be implemented by step 708 and step 710 in FIG. 7, step 808 and 810 in FIG. 8, and step 908 and 910 in FIG. 9 (e.g., via a Nsmf_PDUSession_UpdateSMContext request).

As examples, the first service area may correspond to, e.g., Service area A supported by the SMF1 in FIG. 7, or Service area B supported by the old I-SMF2 in FIG. 8, or Service area B supported by the old I-SMF2 in FIG. 9. The second service area may correspond to, e.g., Service area B supported by the new I-SMF2 in FIG. 7, or Service area C supported by the new I-SMF3 in FIG. 8, or Service area A supported by the SMF1 in FIG. 9.

In step S503 of FIG. 5, when the error indication is generated, the SMF transmits a response message for the service operation including the error indication to the AMF via the SCP.

As an example, the response message for the service operation may be implemented by step 714 and step 716 in FIG. 7, step 814 and step 816 in FIG. 8, in a and step 914 and step 916 FIG. 9 (e.g., via Nsmf_PDUSession_UpdateSMContext response (dedicated error)).

As another example, the response message for the service operation including the error indication may further include an indication to indicate the SCP shall not (or is not to) perform a reselection procedure for this error response. The indication may be included by including a 3gpp-Sbi-Response-Info header with “no-retry=true” in the response message for the service operation. This can avoid unnecessary reselection of the SCP, thus reducing the latency.

As an example, after the error indication is generated, the SMF may wait for an I-SMF procedure to be completed by the AMF without modifying or releasing the PDU session.

In a first exemplary scenario (which may correspond to the use case shown in FIG. 7), if the PDU session is established without an I-SMF, an I-SMF insertion procedure, as the I-SMF procedure, may be performed for inserting an I-SMF supporting the second service area.

In a second exemplary scenario (which may correspond to the use case shown in FIG. 8), if the PDU session has been established with the first SMF (e.g., SMF1) through a first I-SMF (old I-SMF2) supporting the first service area (e.g., service area B), and the second service area (e.g., service area C) is not supported by both the first SMF and the first I-SMF, an I-SMF change procedure, as the I-SMF procedure, may be performed for changing the first I-SMF (old I-SMF2) to a second I-SMF (e.g. new I-SMF3) supporting the second service area (e.g., service area C).

In a third exemplary scenario (which may correspond to the use case shown in FIG. 9), if the PDU session has been established with the first SMF (e.g., SMF1) through an I-SMF (e.g., old I-SMF2) supporting the first service area (e.g., service area B), and the second service area (e.g., service area A) is supported by the first SMF, an I-SMF removal procedure, as the I-SMF procedure, may be completed for removing the I-SMF (e.g., old I-SMF) supporting the first service area.

The method 500 may be applied, for example, in an indirect communication with delegated SMF discovery (Model D) in 5G core after a PDU session establishment procedure.

The role of the SMF can further be a Visited-SMF (V-SMF) or a Home-SMF (H-SMF).

Hereinafter, a method performed by an AMF for handling a PDU session according to an exemplary embodiment of the present disclosure will be described with reference to FIG. 6. The method can be applied after a PDU session has been established with a Service Management Function (SMF).

As shown in FIG. 6, the method 600 includes at least steps S601 and S603.

In step S601 of FIG. 6, after a UE establishes the PDU session with the SMF and moves from the first service area to a second service area which is different from the first service area and not supported by the SMF, the AMF transmits a request message for a service operation to the SMF via a service communication proxy (SCP). The SMF can be a first SMF (e.g., SMF1 in FIG. 7) or an I-SMF (e.g. old I-SMF2 in FIG. 8 or 9) supporting the first service area.

In step S603 of FIG. 6, the AMF receives a response message for the service operation including an error indication from the SMF via the SCP.

As an example, the error indication may be a dedicated error generated for indicating the UE's current location cannot be served by the associated SMF or I-SMF. The error indication may be generated when the following conditions are all met: the UE is out of the first service area of the SMF; and Deployments Topologies with specific SMF Service Areas (DTSSA) is supported by the AMF.

As an example, the request message for the service operation may be implemented by step 708 and step 710 in FIG. 7, step 808 and 810 in FIG. 8, and step 908 and 910 in FIG. 9 (e.g., via a Nsmf_PDUSession_UpdateSMContext request).

As examples, the first service area may correspond to, e.g., Service area A supported by the SMF1 in FIG. 7, or Service area B supported by the old I-SMF2 in FIG. 8, or Service area B supported by the old I-SMF2 in FIG. 9. The second service area may correspond to, e.g., Service area B supported by the new I-SMF2 in FIG. 7, or Service area C supported by the new I-SMF3 in FIG. 8, or Service area A supported by the SMF1 in FIG. 9.

As an example, the response message for the service operation may be implemented by step 714 and step 716 in FIG. 7, step 814 and step 816 in FIG. 8, and step 914 and step 916 in FIG. 9 (e.g., via a Nsmf_PDUSession_UpdateSMContext response (dedicated error)).

As another example, the response message for the service operation including the error indication may further include an indication to indicate the SCP shall not (or is not to) perform a reselection procedure for this error response. The indication may be included by including a 3gpp-Sbi-Response-Info header with “no-retry=true” in the response message for the service operation.

As an example, after the error indication is received, the AMF may perform an I-SMF procedure based on the received response message for the service operation including an error indication.

In a first exemplary scenario (which may correspond to the use case shown in FIG. 7), if the PDU session is established without an I-SMF, an I-SMF insertion procedure, as the I-SMF procedure, may be performed for inserting an I-SMF supporting the second service area.

In a second exemplary scenario (which may correspond to the use case shown in FIG. 8), if the PDU session has been established with the first SMF (e.g., SMF1) through a first I-SMF (old I-SMF2) supporting the first service area (e.g., service area B), and the second service area (e.g., service area C) is not supported by both the first SMF and the first I-SMF, an I-SMF change procedure, as the I-SMF procedure, may be performed for changing the first I-SMF (old I-SMF2) to a second I-SMF (e.g. new I-SMF3) supporting the second service area (e.g., service area C).

In a third exemplary scenario (which may correspond to the use case shown in FIG. 9), if the PDU session has been established with the first SMF (e.g., SMF1) through an I-SMF (e.g., old I-SMF2) supporting the first service area (e.g., service area B), and the second service area (e.g., service area A) is supported by the first SMF, an I-SMF removal procedure, as the I-SMF procedure, may be completed for removing the I-SMF (e.g., old I-SMF) supporting the first service area.

The method 600 may be applied, for example, in an indirect communication with delegated SMF discovery (Model D) in 5G core after a PDU session establishment procedure.

The AMF may perform an NRF discovery from the NRF with a service instance identifier (ID) of the first SMF (e.g., SMF1 in FIGS. 7-9) to get (or acquire) supported service areas of the first SMF (e.g., via steps 10-11 in FIGS. 7-9), which may be used to determine the need for I-SMF removal upon subsequent UE mobility in future.

The AMF may obtain supported service areas of the I-SMF (e.g., new I-SMF in FIG. 7) or the second I-SMF from NRF (e.g., new I-SMF3 in FIG. 8).

FIG. 7 schematically shows an exemplary signaling diagram of PDU Session

Establishment with DTSSA in Model D where a method performed by a SMF and/or an AMF according to exemplary embodiments of the present disclosure is applied. Some description of the exemplary signaling sequence diagram as shown in FIG. 7 may refer to that of methods 500 and 600 as previously described, and thus will be omitted here for simplicity.

As shown in FIG. 7, use case 1 is described where PDU session is established without an I-SMF, and an I-SMF is inserted due to UE mobility. Particularly, the following steps may be performed. The steps can involve any one or more of a UE (or RAN) 10, an NRF 20, an AMF 30, an SCP 40, an SMF (“SMF 1”) 50, and an I-SMF (“I-SMF 2”) 60.

Steps 700 to 710 of FIG. 7 are the same as steps 200 to 210 of FIG. 3.

In step 712 of FIG. 7, the UE 10 is outside of the service area supported by the SMF1 50. At the receipt of a Nsmf_PDUSession_UpdateSMContext request, the SMF1 50 shall (or is to) generate a dedicated error to indicate that the error is caused by an out of service area of the SMF1 50, and the SMF1 50 shall not (or is not to) modify or release the PDU session but wait for the AMF 30 to complete the I-SMF procedure to avoid traffic impact on the existing PDU session. The SMF1 50 may generate the dedicated error when one or both of the below conditions are met:
The UE is outside of the service area of the SMF
DTSSA is supported by the AMF.

In the error response, the SMF1 50 may also include a 3gpp-Sbi-Response-Info header with “no-retry=true” to indicate the SCP 40 shall not (or is not to) perform the reselection for this error response.

In step 714 of FIG. 7, the SMF1 50 sends the Nsmf_PDUSession_UpdateSMContext response with the dedicated error to the SCP 40. Thus, the SCP 40 can receive the Nsmf_PDUSession_UpdateSMContext response with the dedicated error from the SMF1 50. The error identifies the situation, i.e. the associated SMF1 50 does not serve the UE's location. In step 716 of FIG. 7, the SCP 40 forwards the Nsmf_PDUSession_UpdateSMContext response to the AMF 30. Thus, the AMF 30 can receive the Nsmf_PDUSession_UpdateSMContext response from the SCP 40. At the reception of the Nsmf_PDUSession_UpdateSMContext response with the dedicated error, the AMF 30 knows that the associated SMF1 50 does not serve the UE's location and may execute the I-SMF insertion procedure. As the SMF1 50 service instance ID has been already known during (or is already known from) the PDU session establishment procedure, in step 718 to 722 of FIG. 7, the AMF 30 can perform the NRF discovery with the SMF1 service instance ID from the NRF 20 to get (acquire) the supported service areas of the SMF1 50, which can be used to determine the need for I-SMF removal upon subsequent UE mobility in the future. Alternatively, these steps of NRF discovery of the SMF1's service area can be performed after steps 724 to 732, since it is for the future usage and does not impact the I-SMF insertion procedure.

In steps 724 to 732 of FIG. 7, the steps 4-7 described in clause 5.34.3 of 3GPP TS 23.501 are reused to complete the I-SMF insertion procedure and obtain the SMF service area of the new I-SMF 60 from the NRF 20.

FIG. 8 schematically shows another exemplary signaling diagram of PDU Session Establishment with DTSSA in Model D where a method performed by a SMF and/or an AMF according to exemplary embodiments of the present disclosure is applied. Some description of the exemplary signaling sequence diagram as shown in FIG. 8 may refer to that of methods 500 and 600 as previously described, and thus will be omitted here for simplicity.

As shown in FIG. 8, use case 2a is described where PDU session is established with an I-SMF, and the I-SMF is changed due to UE mobility. Particularly, the following steps may be performed. The steps can involve any one or more of a UE (or RAN) 10, an NRF 20, an AMF 30, an SCP 40, an SMF (“SMF 1”) 50, an I-SMF (“I-SMF 2”) 60, and another I-SMF (“I-SMF 3”) 70.

Steps 800 to 810 of FIG. 8 are the same as steps 300 to 310 of FIG. 4.

In step 812 of FIG. 8, the UE is outside of the service area supported by the I-SMF2 60. At the receipt of a Nsmf_PDUSession_UpdateSMContext request, the I-SMF2 60 shall (or is to) generate a dedicated error to indicate that the error is caused by an out of service area of the I-SMF2 60, and I-SMF2 60 shall not (or is not to) modify or release the PDU session but wait for the AMF 30 to complete the I-SMF procedure to avoid traffic impact on the existing PDU session. The I-SMF2 60 may generate the dedicated error when one or both of the below conditions are met:
The UE is outside of the service area of the I-SMF
DTSSA is supported by the AMF.

In the error response, the I-SMF2 60 may also include a 3gpp-Sbi-Response-Info header with “no-retry=true” to indicate the SCP 40 shall not (or is not to) perform the reselection for this error response.

In step 814 of FIG. 8, the I-SMF2 60 sends the Nsmf_PDUSession_UpdateSMContext response with the dedicated error to the SCP 40. Thus, the SCP 40 can receive the Nsmf_PDUSession_UpdateSMContext response with the dedicated error from I-SMF2 60. The error identifies the situation, i.e. the associated I-SMF2 60 does not serve the UE's location. In step 816 of FIG. 8, the SCP 40 forwards the Nsmf_PDUSession_UpdateSMContext response to the AMF 30. Thus, the AMF 30 can receive the Nsmf_PDUSession_UpdateSMContext response from the SCP 40.

At the receipt of the Nsmf_PDUSession_UpdateSMContext response with the dedicated error, the AMF 30 knows that the associated I-SMF2 60 does not serve the UE's location and may execute the I-SMF change or removal procedure. As the SMF1 service instance ID has been already known during (or is already known from) the PDU session establishment procedure, in step 818 to 822 of FIG. 8, the AMF 30 can perform the discovery with the SMF1 service instance ID from the NRF 20 to get (acquire) the supported service areas of the SMF1 50. In this example, the UE's new location is not supported by the SMF1 50, and I-SMF change procedure may be executed.

In steps 824 to 834 of FIG. 8, the steps 4-7 described in clause 5.34.3 of 3GPP TS 23.501 are reused to complete the I-SMF change procedure and obtain the SMF service area of the new I-SMF3 70 from the NRF 20 with below deviations:
Whether the AMF 30 sends the Nsmf_PDUSession_CreateSMContext or Nsmf_PDUSession_UpdateSMContext request depends on different scenarios, e.g. as indicated in clause 4.23.4.3 of 3GPP TS 23.502.
The SM Context ID shall (or is to) point to the old I-SMF2 60 in this case 2a for an I-SMF change.
The new I-SMF3 70 and the SMF1 50 will complete the I-SMF change procedure, e.g. as indicated in the clause 4.23.4.3 of 3GPP TS 23.502.

FIG. 9 schematically shows another exemplary signaling diagram of PDU Session Establishment with DTSSA in Model D where a method performed by a SMF and/or an AMF according to exemplary embodiments of the present disclosure is applied. Some description of the exemplary signaling sequence diagram as shown in FIG. 9 may refer to that of methods 500 and 600 as previously described, and thus will be omitted here for simplicity.

As shown in FIG. 9, use case 2b is described where PDU session is established with an I-SMF, and the I-SMF is removed due to UE mobility. Particularly, the following steps may be performed. The steps can involve any one or more of a UE (or RAN) 10, an NRF 20, an AMF 30, an SCP 40, an SMF (“SMF 1”) 50, and an I-SMF (“I-SMF 2”) 60.

Steps 900 to 916 of FIG. 9 are the same as steps 800 to 816 of FIG. 8.

At the receipt of the Nsmf_PDUSession_UpdateSMContext response with the dedicated error, the AMF 30 knows that the associated I-SMF2 60 does not serve the UE's location and may execute the I-SMF change or removal procedure. As the SMF1 service instance ID has been already known during or is already known from) the PDU session establishment procedure, in step 918 to 922 of FIG. 9, the AMF 30 can perform the discovery with the SMF1 service instance ID from the NRF 20 to get (acquire) the supported service areas of the SMF1 50. In this example, the UE's new location is supported by the SMF1 50, and an I-SMF removal procedure may be executed.

In step 924 of FIG. 9, the AMF 30 sends the Nsmf_PDUSession_CreateSMContext or Nsmf_PDUSession_UpdateSMContext request to the SCP 40. Thus, the SCP 40 receives the Nsmf_PDUSession_CreateSMContext or Nsmf_PDUSession_UpdateSMContext request from the AMF 30. Whether the AMF 30 sends the Nsmf_PDUSession_CreateSMContext or Nsmf_PDUSession_UpdateSMContext request depends on different scenarios, e.g. as indicated in clause 4.23.4.3 of 3GPP TS 23.502. In either case, the request shall (or is not) include a 3gpp-sbi-target-apiRoot header pointing to the SMF1 50.

In step 926 of FIG. 9, the SCP 40 forwards the Nsmf_PDUSession_CreateSMContext or Nsmf_PDUSession_UpdateSMContext request to the SMF1 50 according to the 3gpp-sbi-target-apiRoot header. Thus, the SMF1 50 receives the Nsmf_PDUSession_CreateSMContext or Nsmf_PDUSession_UpdateSMContext request from the SCP 40. The SMF1 50 will complete the I-SMF removal procedure, e.g. as indicated in clause 4.23.4.3 of 3GPP TS 23.502.

The present disclosure thus proposes technical solutions capable of at least supporting the DTSSA with UE mobility for handling a PDU session, e.g. in model D. Briefly, for example, at the receipt of a Nsmf_PDUSession_UpdateSMContext request, the SMF/I-SMF may generate a dedicated error to the AMF and wait for the AMF to complete the I-SMF insertion/change/removal procedure, e.g. when the below conditions are all met:
UE is outside of the Service Area of SMF; and
DTSSA is supported by AMF.

At the receipt of a Nsmf_PDUSession_UpdateSMContext response with a dedicated error, the AMF knows that the associated SMF/I-SMF does not serve the UE's location and may execute the relevant I-SMF procedure accordingly.

The AMF may perform the NRF discovery with the SMF service instance ID from the NRF to get (acquire) the supported service areas of the SMF, which may be used to determine the need for I-SMF change/removal upon subsequent UE mobility in the future.

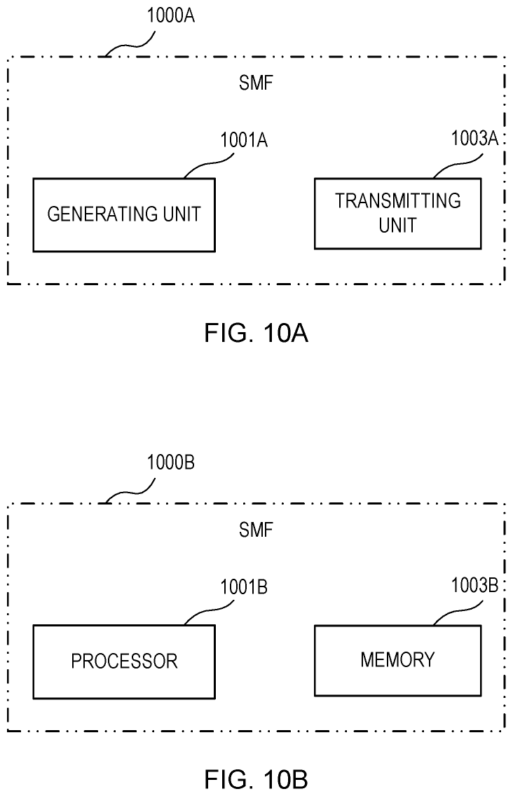

FIGS. 10A-10B schematically show structural block diagrams of an SMF for handling a PDU session according to exemplary embodiments of the present disclosure.

In one embodiment, as shown in FIG. 10A, the SMF 1000A may include a generating unit 1001A and a transmitting unit 1003A.

The generating unit 1001A may be configured to generate an error indication when receiving a request message for a service operation via a service communication proxy (SCP) from an Access and Mobility Management Function (AMF) after a UE establishes the PDU session with the SMF and moves from a first service area to a second service area. The second service area is different from the first service area and not supported by the SMF. The SMF can be a first SMF (e.g., SMF1 in FIG. 7) or an I-SMF (e.g. old I-SMF2 in FIG. 8 or 9) supporting the first service area.

The transmitting unit 1003A may be configured to transmit a response message for the service operation including the error indication to the AMF via the SCP.

Alternatively, as shown in FIG. 10B, the SMF 1000B may include at least one processor 1001B and optionally also at least one memory 1003B. The at least one processor 1001B includes e.g., any suitable Central Processing Unit (CPU), microcontroller, Digital Signal Processor (DSP), etc., capable of executing computer program instructions. The at least one memory 1003B may be any combination of a Random Access Memory (RAM) and a Read Only Memory (ROM). The at least one memory 1003B may also include persistent storage, which, for example, can be any single one or combination of magnetic memory, optical memory, or solid state memory or even remotely mounted memory.

The at least one memory 1003B stores instructions executable by the at least one processor 1001B. The instructions, when loaded from the at least one memory 1003B and executed on the at least one processor 1001B, may cause the SMF to perform the actions, e.g., of the procedures as described earlier in conjunction with FIGS. 5 and 7-9, and thus will be omitted here for simplicity.

The SMF 1000A and 1000B in FIGS. 10A-10B may perform the method 500 with reference to FIG. 5 and signaling sequence diagrams with reference to FIGS. 7-9. Accordingly, some detailed description and features on the SMF 1000A and 1000B may refer to the corresponding description of the method 500 as shown in FIG. 5 in conjunction with the signaling sequence diagrams as shown in FIGS. 7-9, and thus will be omitted here for simplicity.

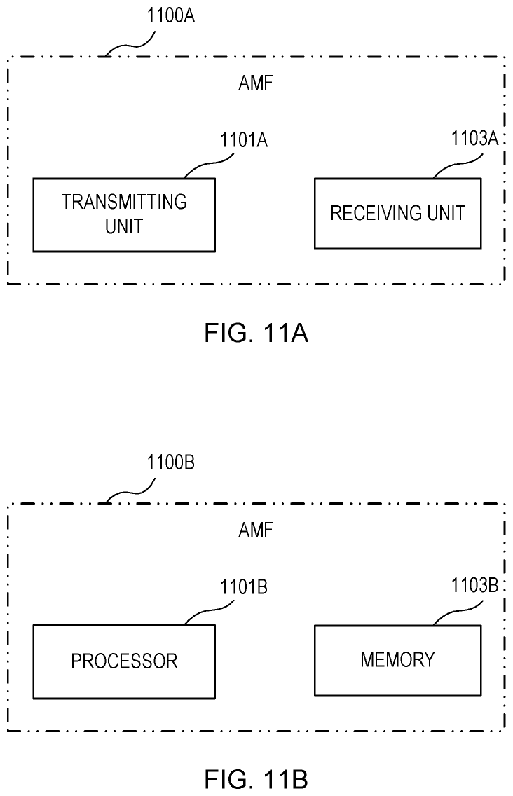

FIGS. 11A-11B schematically show structural block diagrams of an AMF for handling a PDU session according to exemplary embodiments of the present disclosure.

As shown in FIG. 11A, the AMF 1100A may include a transmitting unit 1101A and a receiving unit 1103A.

The transmitting unit 1101A may be configured to transmit a request message for a service operation to the SMF via a service communication proxy, SCP, after a UE establishes the PDU session with the SMF and moves from a first service area to a second service area. The second service area is different from the first service area and not supported by the SMF. The SMF can be a first SMF (e.g., SMF1 in FIG. 7) or an I-SMF (e.g. old I-SMF2 in FIG. 8 or 9) supporting the first service area.

The receiving unit 1103A may be configured to receive a response message for the service operation including an error indication from the SMF via the SCP.

Alternatively, as shown in FIG. 11B, the AMF 1100B may include at least one processor 1101B and optionally also at least one memory 1103B. The at least one processor 1101B includes e.g., any suitable CPU, microcontroller, DSP (, etc., capable of executing computer program instructions. The at least one memory 1103B may be any combination of a RAM and a ROM. The at least one memory 1103B may also include persistent storage, which, for example, can be any single one or combination of magnetic memory, optical memory, or solid state memory or even remotely mounted memory.

The at least one memory 1103B stores instructions executable by the at least one processor 1101B. The instructions, when loaded from the at least one memory 1103B and executed on the at least one processor 1101B, may cause the AMF to perform the actions, e.g., of the procedures as described earlier in conjunction with FIGS. 6 and 7-9, and thus will be omitted here for simplicity.

The AMF 1100A and 1100B in FIGS. 11A-11B may perform the method 600 with reference to FIG. 6 and signaling sequence diagrams with reference to FIGS. 7-9. Accordingly, some detailed description and features on the AMF 1100A and 1100B may refer to the corresponding description of the method 600 as shown in FIG. 6 in conjunction with the signaling sequence diagrams as shown in FIGS. 7-9, and thus will be omitted here for simplicity.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program.

The computer program includes: code/computer readable instructions, which when executed by the at least one processor 1001B causes the SMF 1000B to perform the actions, e.g., of the procedures described earlier in conjunction with FIGS. 5 and 7-9; and/or code/computer readable instructions, which when executed by the at least one processor 1101B causes the AMF 1100B to perform the actions, e.g., of the procedures described earlier respectively in conjunction with FIGS. 6 and 7-9.

The computer program product may be configured as a computer program code structured in computer program modules. The computer program modules could essentially perform the actions of the flow illustrated in any of FIGS. 5-9.

The processor may be a single CPU, but could also include two or more processing units. For example, the processor may include general purpose microprocessors; instruction set processors and/or related chips sets and/or special purpose microprocessors such as Application Specific Integrated Circuit (ASICs). The processor may also include board memory for caching purposes. The computer program may be carried by a computer program product connected to the processor. The computer program product may include a non-transitory computer readable storage medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories.

Other embodiments of the present disclosure are defined in the following numbered statements:
Statement 1. A method (500) performed by a Service Management Function, SMF, for handling a PDU session, comprising:
generating (S501) an error indication when receiving a request message for service operation via a service communication proxy, SCP, from an Access and Mobility Management Function, AMF, after a UE establishes the PDU session with the SMF and moves from a first service area to a second service area which is different from the first service area and not supported by the SMF, the SMF being a first SMF or an intermediate SMF, I-SMF, supporting the first service area; and
transmitting (S503) a response message for service operation including the error indication to the AMF via the SCP.
Statement 2. The method of Statement 1, further comprising:
waiting for an Intermediate-SMF, I-SMF, procedure to be completed by the AMF without modifying or releasing the PDU session.
Statement 3. The method of Statement 1, wherein the error indication is generated when following conditions are all met: the UE is out of the first service area of the SMF; and Deployments Topologies with specific SMF Service Areas, DTSSA, is supported by the AMF.
Statement 4. The method of Statement 1, wherein the response message for service operation including the error indication further includes an indication to indicate the SCP shall not perform a reselection procedure for this error response.
Statement 5. The method of Statement 4, wherein the indication is included by including a 3gpp-Sbi-Response-Info header with “no-retry=true” in the response message for service operation.
Statement 6. The method of any of Statements 1-5, wherein if the PDU session is established without an I-SMF, an I-SMF insertion procedure, as the I-SMF procedure, is performed for inserting an I-SMF supporting the second service area.
Statement 7. The method of any of Statements 1-5, wherein if the PDU session is established with the first SMF through a first I-SMF supporting the first service area, and the second service area is not supported by both the first SMF and the first I-SMF, an I-SMF change procedure, as the I-SMF procedure, is performed for changing the first I-SMF to a second I-SMF supporting the second service area.
Statement 8. The method of any of Statements 1-5, wherein if the PDU session is established with the first SMF through an I-SMF supporting the first service area, and the second service area is supported by the first SMF, an I-SMF removal procedure, as the I-SMF procedure, is completed for removing the I-SMF supporting the first service area.
Statement 9. The method of Statement 1, wherein the method is applied in an indirect communication with delegated SMF discovery, i.e., Model D, in 5G core after PDU session establishment procedure.
Statement 10. The method of Statement 1, wherein a role of the SMF can further be a Visited-SMF or a Home-SMF.
Statement 11. A method (600) performed by an Access and Mobility Management Function, AMF, for handling a PDU session, comprising:
transmitting (S601) a request message for service operation to the SMF via a service communication proxy, SCP, after a UE establishes the PDU session with the SMF and moves from a first service area to a second service area which is different from the first service area and not supported by the SMF, the SMF being a first SMF or an intermediate SMF, I-SMF, supporting the first service area; and receiving (S603) a response message for service operation including an error indication from the SMF via the SCP.
Statement 12. The method of Statement 11, further comprising:
performing an I-SMF procedure based on the received response message for service operation including an error indication.
Statement 13. The method of Statement 11, wherein the error indication is generated when following conditions are all met: the UE is out of the first service area of the SMF; and Deployments Topologies with specific SMF Service Areas, DTSSA, is supported by the AMF.
Statement 14. The method of Statement 11, wherein the response message for service operation including the error indication further includes an indication to indicate the SCP shall not perform a reselection procedure for this error response.
Statement 15. The method of Statement 14, wherein the indication is included by including a 3gpp-Sbi-Response-Info header with “no-retry=true” in the response message for service operation.
Statement 16. The method of any of Statements 11-15, wherein if the PDU session is established without an I-SMF, an I-SMF insertion procedure, as the I-SMF procedure, is performed for inserting an I-SMF supporting the second service area.
Statement 17. The method of any of Statements 11-15, wherein if the PDU session is established with the first SMF through a first I-SMF supporting the first service area, and the second service area is not supported by both the first SMF and the first I-SMF, an I-SMF change procedure, as the I-SMF procedure, is performed for changing the first I-SMF to a second I-SMF supporting the second service area.
Statement 18. The method of any of Statements 11-15, wherein if the PDU session is established with the first SMF through an I-SMF supporting the first service area, and the second service area is supported by the first SMF, an I-SMF removal procedure, as the I-SMF procedure, is performed for removing the I-SMF supporting the first service area.
Statement 19. The method of any of Statements 11-15, further comprising: performing Network Repository Function, NRF, discovery from the NRF with a service instance ID of the first SMF to get supported service areas of the first SMF.
Statement 20. The method of Statement 16 or 17, further comprising: obtaining supported service areas of the I-SMF or the second I-SMF from NRF.
Statement 21. The method of Statement 11, wherein the method is applied in an indirect communication with delegated SMF discovery, i.e., Model D, in 5G core after PDU session establishment procedure.
Statement 22. The method of Statement 11, wherein a role of the SMF can further be a Visited-SMF or a Home-SMF.
Statement 23. A Service Management Function (1000A), SMF, for handling a PDU session, comprising:
a generating unit (1001A) configured to generate an error indication when receiving a request message for service operation via a service communication proxy, SCP, from an Access and Mobility Management Function, AMF, after a UE establishes the PDU session with the SMF and moves from a first service area to a second service area which is different from the first service area and not supported by the SMF, the SMF being a first SMF or an intermediate SMF, I-SMF, supporting the first service area; and
a transmitting unit (1003A) configured to transmit a response message for service operation including the error indication to the AMF via the SCP.
Statement 24. A Service Management Function (1000B), SMF, for handling a PDU session, comprising:
at least one processor (1001B), and
at least one memory (1003B), storing instructions which, when executed on the at least one processor, cause the SMF to:
   generating an error indication when receiving a request message for service operation via a service communication proxy, SCP, from an Access and Mobility Management Function, AMF, after a UE establishes the PDU session with the SMF and moves from a first service area to a second service area which is different from the first service area and not supported by the SMF, the SMF being a first SMF or an intermediate SMF, I-SMF, supporting the first service area; and
   transmitting a response message for service operation including the error indication to the AMF via the SCP.
Statement 25. The SMF of Statement 24, wherein the instructions, when executed on the at least one processor, further cause the SMF to perform the method according to any of Statements 2 to 10.
Statement 26. An Access and Mobility Management Function (1100A), AMF, for handling a PDU session, comprising:
a transmitting unit (1101A) configured to transmit a request message for service operation to the SMF via a service communication proxy, SCP, after a UE establishes the PDU session with the SMF and moves from a first service area to a second service area which is different from the first service area and not supported by the SMF, the SMF being a first SMF or an intermediate SMF, I-SMF, supporting the first service area; and
a receiving unit (1103A) configured to receive a response message for service operation including an error indication from the SMF via the SCP.
Statement 27. An Access and Mobility Management Function (1100B), AMF, for handling a PDU session, comprising:
at least one processor (1101B), and
at least one memory (1103B), storing instructions which, when executed on the at least one processor, cause the AMF to:
   transmitting a request message for service operation to the SMF via a service communication proxy, SCP, after a UE establishes the PDU session with the SMF and moves from a first service area to a second service area which is different from the first service area and not supported by the SMF, the SMF being a first SMF or an intermediate SMF, I-SMF, supporting the first service area; and
   receiving a response message for service operation including an error indication from the SMF via the SCP.
Statement 28. The AMF of Statement 27, wherein the instructions, when executed on the at least one processor, further cause the AMF to perform the method according to any of Statements 12 to 22.
Statement 29. A computer readable storage medium having a computer program including computer program instructions stored thereon, the computer program instructions, when executed by a processor in a network device, causing the network device to perform the method according to any of Statements 1 to 10 or any of Statements 11-22.
Statement 30. A computer program comprising computer program instructions which, when executed by a processor in a network device, causing the network device to perform the method according to any of Statements 1 to 10 or any of Statements 11-22.
Statement 31. A computer program product comprising a computer program according to Statement 30 and a computer readable storage medium according to Statements 29.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the present disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the present disclosure may also be written in conventional procedural programming languages, such as the “C” programming language. The program code may execute entirely on a user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and sub-combination of these embodiments. Accordingly, all embodiments can be combined in any way and/or combination, and the present specification, including the drawings, shall be construed to constitute a complete written description of all combinations and sub-combinations of the embodiments described herein, and of the manner and process of making and using them, and shall support claims to any such combination or sub-combination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

1-20. (canceled)

21. A method performed by a Service Management Function (SMF) for handling a Protocol Data Unit (PDU) session, the method comprising:
generating an error indication when receiving a request message for a service operation via a service communication proxy (SCP) from an Access and Mobility Management Function (AMF) after a User Equipment, UE, establishes the PDU session with the SMF and moves from a first service area to a second service area which is different from the first service area and not supported by the SMF, the SMF being a first SMF or an intermediate SMF (I-SMF) supporting the first service area; and
transmitting a response message for the service operation including the error indication to the AMF via the SCP.

22. The method of claim 21, wherein the error indication is generated when the following conditions are all met:
the UE is out of the first service area of the SMF; and
Deployments Topologies with specific SMF Service Areas (DTSSA) is supported by the AMF.

23. The method of claim 21, wherein the response message for the service operation including the error indication further includes an indication to indicate the SCP shall not perform a reselection procedure for this error response.

24. The method of claim 23, wherein a 3gpp-Sbi-Response-Info header of the response message for the service operation comprises the indication to indicate the SCP shall not perform a reselection procedure for this error response.

25. The method of claim 21, further comprising:
waiting for an Intermediate-SMF (I-SMF) procedure to be completed by the AMF without modifying or releasing the PDU session.

26. The method of claim 25, wherein:
if the PDU session is established without an I-SMF, an I-SMF insertion procedure, as the I-SMF procedure, is performed for inserting an I-SMF supporting the second service area;
if the PDU session is established with the first SMF through a first I-SMF supporting the first service area, and the second service area is not supported by both the first SMF and the first I-SMF, an I-SMF change procedure, as the I-SMF procedure, is performed for changing the first I-SMF to a second I-SMF supporting the second service area; or
if the PDU session is established with the first SMF through an I-SMF supporting the first service area, and the second service area is supported by the first SMF, an I-SMF removal procedure, as the I-SMF procedure, is completed for removing the I-SMF supporting the first service area.

27. The method of claim 21, wherein the method is applied in an indirect communication with delegated SMF discovery in a fifth generation (5G) core after a PDU session establishment procedure.

28. The method of claim 21, wherein the SMF is a Visited-SMF or a Home-SMF.

29. A method performed by an Access and Mobility Management Function (AMF) for handling a Protocol Data Unit (PDU) session, the method comprising:
transmitting a request message for a service operation to the SMF via a service communication proxy (SCP) after a User Equipment, UE establishes the PDU session with the SMF and moves from a first service area to a second service area which is different from the first service area and not supported by the SMF, the SMF being a first SMF or an intermediate SMF (I-SMF) supporting the first service area; and
receiving a response message for the service operation including an error indication from the SMF via the SCP.

30. The method of claim 29, wherein the error indication is generated when following the conditions are all met:
the UE is out of the first service area of the SMF; and
Deployments Topologies with specific SMF Service Areas (DTSSA) is supported by the AMF.

31. The method of claim 29, wherein the response message for the service operation including the error indication further includes an indication to indicate the SCP shall not perform a reselection procedure for this error response.

32. The method of claim 31, wherein a 3gpp-Sbi-Response-Info header of the response message for the service operation comprises the indication to indicate the SCP shall not perform a reselection procedure for this error response.

33. The method of claim 29, further comprising:
performing an I-SMF procedure based on the received response message for the service operation including an error indication.

34. The method of claim 33, wherein:
if the PDU session is established without an I-SMF, an I-SMF insertion procedure, as the I-SMF procedure, is performed for inserting an I-SMF supporting the second service area;
if the PDU session is established with the first SMF through a first I-SMF supporting the first service area, and the second service area is not supported by both the first SMF and the first I-SMF, an I-SMF change procedure, as the I-SMF procedure, is performed for changing the first I-SMF to a second I-SMF supporting the second service area; or
if the PDU session is established with the first SMF through an I-SMF supporting the first service area, and the second service area is supported by the first SMF, an I-SMF removal procedure, as the I-SMF procedure, is performed for removing the I-SMF supporting the first service area.

35. The method of claim 29, further comprising:
performing Network Repository Function (NRF) discovery from the NRF with a service instance identifier (ID) of the first SMF to get supported service areas of the first SMF.

36. The method of claim 29, wherein the method is applied in an indirect communication with delegated SMF discovery in a fifth generation (5G) core after a PDU session establishment procedure.

37. The method of claim 29, wherein the SMF is a Visited-SMF or a Home-SMF.

38. A Service Management Function (SMF) comprising:
at least one processor configured to operate in accordance with claim 21.

39. An Access and Mobility Management Function (AMF) comprising:
at least one processor configured to operate in accordance with claim 29.

40. A non-transitory computer-readable medium comprising, stored thereupon, a computer program comprising instructions configured so that execution of the instructions by at least one processor will cause the at least one processor to perform the method of claim 21.
